(19) United States
(12) Patent Application Publication
(10) Pub. No.: US 2025/0147532 A1
(43) Pub. Date: May 8, 2025

(54) REFERENCE VOLTAGE GENERATION CIRCUIT AND ELECTRONIC DEVICE

(71) Applicant: Sony Semiconductor Solutions Corporation, Kanagawa (JP)

(72) Inventor: Kenya Kondo, Fukuoka (JP)

(21) Appl. No.: 18/724,424

(22) PCT Filed: Nov. 16, 2022
(86) PCT No.: PCT/JP2022/042509

§ 371 Date: Jan. 13, 2025

(30) Foreign Application Priority Data
Jan. 11, 2022 (JP) 2022-002191

(51) Int. Cl. G05F 1/567

(52) U.S. Cl. CPC G05F 1/567

(57) ABSTRACT

Circuitry that generates a constant reference voltage with reduced minimum operating voltage is disclosed. In one example, a PTAT current generation unit includes first and second current sources connected in parallel to one of a power supply voltage and a ground voltage, two bipolar transistors connected in parallel to a current mirror circuit including the current sources, and a first resistor which is connected to an emitter of one of the bipolar transistors. A CTAT current generation unit includes a third current source and a second resistor inserted in series between the power supply and ground voltages. A connection node between the third current source and the second resistor is connected in common to gates of the bipolar transistors. A reference voltage is output according to addition of a PTAT current supplied by the first and second current sources and a CTAT current supplied by the third current source.

### TECHNICAL FIELD

The present technology relates to a reference voltage generation circuit. Specifically, the present technology relates to a reference voltage generation circuit of a bandgap reference method and an electronic device.

### BACKGROUND ART

Conventionally, a bandgap reference method has been used to generate a constant voltage independent of a power supply voltage and a temperature. The bandgap reference methods are classified into a voltage addition type and a current addition type. Among these types, the voltage addition type is a method of adding a proportional to absolute temperature (PTAT) voltage and a complementary to absolute temperature (CTAT) voltage. In contrast, the current addition type is a method of adding a PTAT current and a CTAT current. For example, a current addition type reference voltage generation circuit that generates a CTAT current by a circuit in which a common-drain transistor (that is, a source follower) and a resistor are connected in series to a current mirror circuit without using an operational amplifier has been proposed (See, for example, Non-Patent Document 1).

### CITATION LIST

### Non-Patent Document

Non-Patent Document 1: Jun Yin, et al., A system-on-Chip EPC Gen-2 passive UHF RFID tag with embedded temperature sensor, IEEE JOURNAL OF SOLID-STATE CIRCUITS, 2010.

### SUMMARY OF THE INVENTION

### Problems to be Solved by the Invention

In the above-described conventional technology, reduction in the minimum operating voltage, reduction in offset variation, and reduction in the circuit area are achieved by omitting an operational amplifier compared with the case of using an operational amplifier. However, in the above-described reference voltage generation circuit, it is difficult to further reduce the minimum operating voltage.

The present technology has been made in view of such a situation, and an object thereof is to reduce a minimum operating voltage in a circuit that generates a constant reference voltage.

### Solutions to Problems

The present technology has been made to solve the above-described problem, and a first aspect thereof is a reference voltage generation circuit including: a proportional to absolute temperature (PTAT) current generation unit including a first current source and a second current source which are connected in parallel to one of a power supply voltage and a ground voltage, a pair of bipolar transistors which is connected in parallel to a current mirror circuit including the first current source and the second current source, and a first resistor which is connected to an emitter of one of the pair of bipolar transistors; a complementary to absolute temperature (CTAT) current generation unit which includes a third current source and a second resistor that are inserted in series between the power supply voltage and the ground voltage, and in which a connection node between the third current source and the second resistor is connected in common to gates of the pair of bipolar transistors; and an output unit which outputs a reference voltage according to an addition value of a PTAT current supplied by the first current source and the second current source and a CTAT current supplied by the third current source. With this arrangement, an effect of lowering the minimum operating voltage of the reference voltage generation circuit is brought about.

Furthermore, in the first aspect, the output unit may include a fourth current source which replicates the CTAT current and supplies the CTAT current that has been replicated, a fifth current source which replicates the PTAT current and supplies the PTAT current that has been replicated, and a third resistor which is connected in common to the fourth current source and the fifth current source. With this arrangement, an effect of generating a reference voltage having a value obtained by multiplying the addition value of the currents by a resistance value is brought about.

Furthermore, in the first aspect, the first current source, the second current source, the third current source, the fourth current source, and the fifth current source may be metal oxide semiconductor (MOS) transistors. With this arrangement, an effect that currents supplied from the MOS transistors are added is brought about.

Furthermore, in the first aspect, the first current source, the second current source, the third current source, the fourth current source, and the fifth current source may be bipolar transistors. With this arrangement, an effect that currents supplied from the bipolar transistors are added is brought about.

Furthermore, in the first aspect, the first current source, the second current source, the third current source, the fourth current source, and the fifth current source may be connected in parallel to the power supply voltage. With this arrangement, an effect that currents flowing from the current sources are added is brought about.

Furthermore, in the first aspect, the first current source, the second current source, the third current source, the fourth current source, and the fifth current source may be connected in parallel to the ground voltage. With this arrangement, an effect that currents flowing through the current sources are added is brought about.

Furthermore, in the first aspect, the output unit may further include a sixth current source which replicates the PTAT current and supplies the PTAT current that has been replicated, and the third resistor may be connected in common to the fourth current source, the fifth current source, and the sixth current source. With this arrangement, an effect of canceling the base current is brought about.

Furthermore, in the first aspect, the output unit may further include a fourth resistor which is inserted between the third resistor and the fifth current source, and the fourth current source may be connected to a connection node between the third resistor and the fourth resistor. With this arrangement, an effect of canceling the base current is brought about.

Furthermore, in the first aspect, a base current detection unit which detects a base current of the pair of bipolar transistors may be further included. With this arrangement, an effect of canceling the base current is brought about.

Furthermore, in the first aspect, the base current detection unit may add the base current to the CTAT current supplied by the third current source. With this arrangement, an effect of canceling the base current is brought about.

Furthermore, in the first aspect, the base current detection unit may subtract the base current from a current flowing through the third resistor. With this arrangement, an effect of canceling the base current is brought about.

Furthermore, in the first aspect, the base current detection unit may correct the PTAT current with the base current and output the PTAT current that has been corrected. With this arrangement, an effect of realizing a temperature detection circuit or the like is brought about.

Furthermore, in the first aspect, a replica circuit which generates the PTAT current and supplies the PTAT current to the output unit may be further included, and the output unit may output a current obtained by adding the PTAT current supplied by the replica circuit to the CTAT current as a reference current together with the reference voltage. With this arrangement, an effect that deterioration of stability can be avoided at the time of output expansion is brought about.

Furthermore, in the first aspect, the PTAT current generation unit may include a folded-back differential circuit. With this arrangement, an effect of lowering the minimum operating voltage is brought about.

Furthermore, in the first aspect, a phase compensation capacitor which is inserted between the PTAT current generation unit and a connection node between the third current source and the second resistor may be further included, the PTAT current generation unit may further include a pair of transistors that is cascode connected, and a connection node between the pair of transistors may be connected to the phase compensation capacitor. With this arrangement, an effect of improving the stability of the circuit is brought about.

Furthermore, a second aspect of the present technology is an electronic device including: an integrated circuit: a proportional to absolute temperature (PTAT) current generation unit including a first current source and a second current source which are connected in parallel to one of a power supply voltage and a ground voltage, a pair of bipolar transistors which is connected in parallel to a current mirror circuit including the first current source and the second current source, and a first resistor which is connected to an emitter of one of the pair of bipolar transistors; a complementary to absolute temperature (CTAT) current generation unit which includes a third current source and a second resistor that are inserted in series between the power supply voltage and the ground voltage and in which a connection node between the third current source and the second resistor is connected in common to gates of the pair of bipolar transistors; and an output unit which outputs to the integrated circuit a reference voltage according to an addition value of a PTAT current supplied by the first current source and the second current source and a CTAT current supplied by the third current source. With this arrangement, an effect of lowering the minimum operating voltage of the reference voltage generation circuit in the electronic device is brought about.

### BRIEF DESCRIPTION OF DRAWINGS

FIG. 1 is a block diagram illustrating a configuration example of an electronic device according to a first embodiment of the present technology.

FIG. 2 is a circuit diagram illustrating a configuration example of a reference voltage generation circuit according to the first embodiment of the present technology.

FIG. 3 is a circuit diagram illustrating a specific configuration example of the reference voltage generation circuit according to the first embodiment of the present technology.

FIG. 4 is a circuit diagram illustrating a configuration example of a reference voltage generation circuit in a comparative example.

FIG. 5 is an example of a graph illustrating startup characteristics with respect to a power supply voltage in the first embodiment and the comparative example of the present technology.

FIG. 6 is a graph indicating a Monte Carlo simulation result according to the first embodiment of the present technology.

FIG. 7 is a graph illustrating a Monte Carlo simulation result in the comparative example.

FIG. 8 is a diagram indicating Monte Carlo simulation results in the first embodiment of the present technology and the comparative example.

FIG. 9 is a graph illustrating an example of a power supply voltage-dependent characteristic according to the first embodiment of the present technology.

FIG. 10 is a graph illustrating an example of a power supply voltage-dependent characteristic in the comparative example.

FIG. 11 illustrates graphs each illustrating an example of a power supply rejection ratio (PSRR) characteristic at a same power supply voltage in the first embodiment of the present technology and the comparative example.

FIG. 12 is a graph illustrating an example of a power supply voltage-dependent characteristic of a PSRR characteristic in a low frequency band in each of the first embodiment of the present technology and the comparative example.

FIG. 13 is a circuit diagram illustrating another example of the reference voltage generation circuit according to the first embodiment of the present technology.

FIG. 14 is a circuit diagram illustrating a configuration example of a reference voltage generation circuit according to a second embodiment of the present technology.

FIG. 15 is a circuit diagram illustrating a configuration example of a reference voltage generation circuit according to a third embodiment of the present technology.

FIG. 16 is a graph illustrating examples of temperature dependent characteristics in the third embodiment and the first embodiment of the present technology.

FIG. 17 is a circuit diagram illustrating a configuration example of a reference voltage generation circuit according to a modification of the third embodiment of the present technology.

FIG. 18 is a circuit diagram illustrating a configuration example of a reference voltage generation circuit according to a fourth embodiment of the present technology.

FIG. 19 is a circuit diagram illustrating a configuration example of a reference voltage generation circuit according to a modification of the fourth embodiment of the present technology.

FIG. 20 is a circuit diagram illustrating a configuration example of a reference voltage generation circuit according to a fifth embodiment of the present technology.

FIG. 21 is a circuit diagram illustrating a configuration example of a reference voltage generation circuit according to a sixth embodiment of the present technology.

FIG. 22 is a circuit diagram illustrating a configuration example of a reference voltage generation circuit according to a seventh embodiment of the present technology.

### MODE FOR CARRYING OUT THE INVENTION

Modes for carrying out the present technology (hereinafter, referred to as embodiments) will be described below. The description will be given in the following order.
1. First embodiment (example of generating CTAT current by current source and resistor)
2. Second embodiment (example of disposing current sources on ground side and generating CTAT current by current source and resistor)
3. Third embodiment (example of canceling base current and generating CTAT current by current source and resistor)
4. Fourth embodiment (example of detecting and canceling base current and generating CTAT current with current source and resistor)
5. Fifth embodiment (example of correcting PTAT current and generating CTAT current by current source and resistor)
6. Sixth embodiment (example of expanding output and generating CTAT current by current source and resistor)
7. Seventh embodiment (example of omitting phase compensation capacitor and generating CTAT current by current source and resistor)

### 1. First Embodiment

### [Configuration Example of Electronic Device]

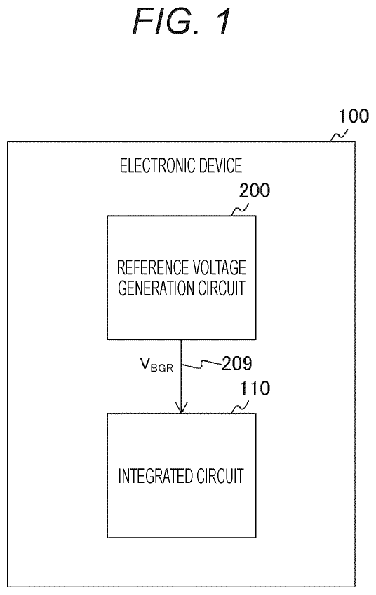

FIG. 1 is a block diagram illustrating a configuration example of an electronic device 100 according to a first embodiment of the present technology. The electronic device 100 includes a reference voltage generation circuit 200 and an integrated circuit 110.

The reference voltage generation circuit 200 generates a constant voltage that does not depend on the power supply voltage or temperature as a reference voltage V_{BGR}. The reference voltage generation circuit 200 supplies the generated voltage to the integrated circuit 110 via an output signal line 209. The integrated circuit 110 is driven by the reference voltage V_{B}m and executes predetermined processing such as arithmetic processing.

### [Configuration Example of Reference Voltage Generation Circuit]

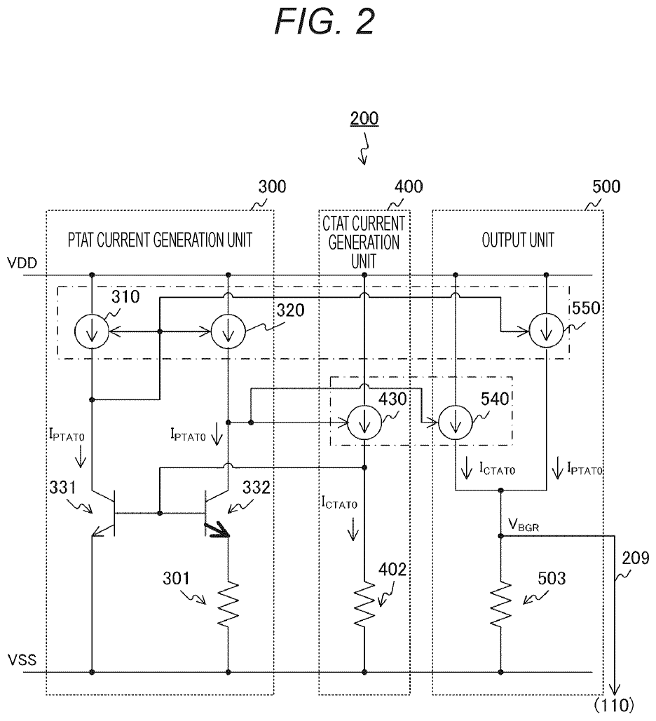

FIG. 2 is a circuit diagram illustrating a configuration example of the reference voltage generation circuit 200 according to the first embodiment of the present technology. The reference voltage generation circuit 200 includes a PTAT current generation unit 300, a CTAT current generation unit 400, and an output unit 500.

The PTAT current generation unit 300 generates a PTAT current whose value changes in proportion to the absolute temperature with a positive temperature coefficient. The PTAT current generation unit 300 includes current sources 310 and 320, bipolar transistors 331 and 332, and a resistor 301.

The CTAT current generation unit 400 generates a CTAT current whose value changes in proportion to the absolute temperature with a negative temperature coefficient. The CTAT current generation unit 400 includes a current source 430 and a resistor 402.

The output unit 500 outputs a voltage corresponding to an addition value of the PTAT current and the CTAT current as the reference voltage V_{BGR}. The output unit 500 includes current sources 540 and 550 and a resistor 503.

In the PTAT current generation unit 300, the current sources 310 and 320 are connected in parallel to one of a power supply voltage VDD and a ground voltage VSS. In the configuration illustrated in FIG. 2, the current sources 310 and 320 are connected in parallel to the power supply voltage VDD. Furthermore, the current sources 310, 320, and 550 constitute a current mirror circuit using the current source 310 as a reference source. In FIG. 2, the circuit surrounded by a constant chain line indicates the current mirror circuit.

The bipolar transistors 331 and 332 differ in size and are connected in parallel to the current mirror circuit that includes the current sources 310 and 320. For example, the area of the bipolar transistor 332 is N (N is an integer) times that of the bipolar transistor 331. As the bipolar transistors 331 and 332, for example, an NPN type is used, and bases of the bipolar transistors 331 and 332 are connected to each other. One end of the resistor 301 is connected to an emitter of the bipolar transistor 332. An emitter of the bipolar transistor 331 and the other end of the resistor 301 are connected to the ground voltage VSS.

Furthermore, in the CTAT current generation unit 400, the current source 430 and the resistor 402 are inserted in series between the power supply voltage VDD and the ground voltage VSS. Furthermore, a connection node between the current source 430 and the resistor 402 is connected in common to the bases of the bipolar transistors 331 and 332. Furthermore, the current sources 430 and 540 constitute a current mirror circuit using the current source 430 as a reference source.

Furthermore, in the output unit 500, the current sources 540 and 550 are connected in parallel to one of the power supply voltage VDD and the ground voltage VSS (power supply voltage VDD in FIG. 2). One end of the resistor 503 is connected in common to the current sources 540 and 550, and the other end is connected to the ground voltage VSS. The voltage of a connection node between the current sources 540, 550 and the resistor 503 is output as the reference voltage V_{BGR}.

Note that the current sources 310, 320, 430, 540, and 550 are examples of a first current source, a second current source, a third current source, a fourth current source, and a fifth current source recited in the claims, respectively. Furthermore, the resistors 301, 402, and 503 are examples of a first resistor, a second resistor, and a third resistor recited in the claims, respectively.

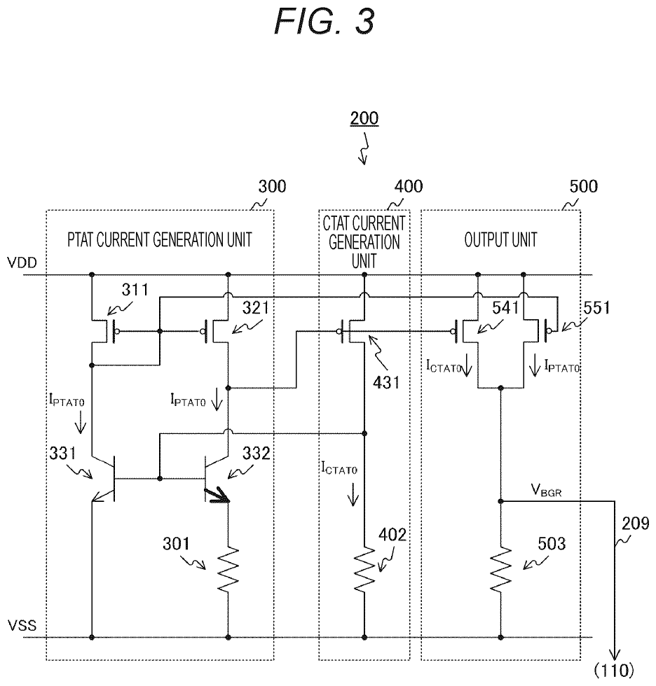

FIG. 3 is a circuit diagram illustrating a specific configuration example of the reference voltage generation circuit 200 according to the first embodiment of the present technology. As the current sources 310, 320, 430, 540, and 550, for example, p-channel metal oxide semiconductor (pMOS) transistors 311, 321, 431, 541, and 551 are used, respectively. It is assumed that the sizes of the pMOS transistors 311, 321, and 551 constituting the current mirror circuit are the same, and the mirror ratio is one time. Furthermore, it is assumed that the sizes of the pMOS transistors 431 and 541 constituting the current mirror circuit are the same, and the mirror ratio is one time. Note that the pMOS transistors 311, 321, 431, 541, and 551 are examples of metal oxide semiconductor (MOS) transistors recited in the claims.

A gate of the pMOS transistor 311 is connected to a drain thereof and a gate of the pMOS transistor 321. A gate of the pMOS transistor 431 is connected to a collector of the bipolar transistor 332. A gate of the pMOS transistor 541 is connected to the gate of the pMOS transistor 431. A gate of the pMOS transistor 551 is connected to the gate of the pMOS transistor 311.

As described above, since the emitter areas of the bipolar transistors 331 and 332 are different from each other, a difference occurs between the base-emitter voltages of the bipolar transistors 331 and 332. The differential voltage ΔV_{be} is expressed by, for example, the following formula.

$$Δ {V}_{be} = {V}_{be 1} - {V}_{be 2} = {V}_{T} ln ( N ) = ( kT / q ) ln ( N ) \qquad Formula 1$$

In the above formula, V_{be1} and V_{be2} are the base-emitter voltages of the bipolar transistors 331 and 332, and V_{T} is a thermal voltage. The unit of these voltages is, for example, volt (V). k is a Boltzmann constant, and the unit is, for example, Joule per Kelvin (J/K). T is an absolute temperature, and the unit is, for example, Kelvin (K). q is an elementary electrical charge, and the unit is, for example, coulomb (C). ln( ) is a function that returns a natural logarithm.

Due to the differential voltage ΔV_{be}, the current flowing through the resistor 301 is proportional to the absolute temperature by Formula 1 and becomes a PTAT current. The PTAT current I_{PTAT0} is expressed by the following formula.

$${I}_{PTAT 0} = Δ {V}_{be} / {R}_{1} \qquad Formula 2$$

In the above formula, the unit of the PTAT current I_{PTAT0} is, for example, amperes (A). R₁ is a resistance value of the resistor 301, and the unit is, for example, ohm (Ω). A value (in other words, the temperature coefficient) obtained by dividing the right side of the above formula by T is a positive value.

Here, in FIG. 3, it is assumed that the current amplification factor of each of the bipolar transistors 331 and 332 is sufficiently large, and the base current thereof can be ignored. The above-described PTAT current I_{PTAT0} is replicated and the replicated PTAT current I_{PTAT0} is output from the pMOS transistor 551.

Furthermore, in the CTAT current generation unit 400, the pMOS transistor 431 and the resistor 402 constitute a common-source amplifier. The output of the common-source amplifier is connected in common to the bases of the bipolar transistors 331 and 332, and the gate of the pMOS transistor 431 is connected to the collector of the bipolar transistor 332 to constitute a feedback circuit. At this time, since the negative feedback is established, the base-emitter voltage V_{be1} of the bipolar transistor 331 is applied to the resistor 402. Since the base-emitter voltage V_{be1} is generally proportional to the temperature by a negative temperature coefficient, the current flowing through the resistor 402 by the voltage becomes a CTAT current. The CTAT current I_{CTAT0} is expressed by the following formula.

$${I}_{CTAT 0} = {V}_{be 1} / {R}_{2} \qquad Formula 3$$

In the above formula, the unit of the CTAT current I_{CTAT0} is, for example, amperes (A). R₂ is a resistance value of the resistor 402, and the unit is, for example, ohm (Ω). A value (in other words, the temperature coefficient) obtained by dividing the right side of the above formula by T is a negative value.

The above-described CTAT current I_{CTAT0} is replicated and the replicated CTAT current I_{CTAT0} is output from the pMOS transistor 541. In the output unit 500, a current of the addition value of the PTAT current I_{PTAT0} and the CTAT current I_{CTAT0} flows through the resistor 503. This current becomes a value that does not depend on the absolute temperature by making the positive and negative temperature coefficients substantially the same. Therefore, the voltage generated in the resistor 503 by the current is output as the reference voltage V_{BGR}. The reference voltage V_{BGR} is expressed by the following formula on the basis of Formulas 2 and 3.

$$\begin{matrix}{V}_{BGR} = {R}_{3} ( {I}_{PTAT 0} + {I}_{CTAT 0} ) \\ = {R}_{3} \{ ( Δ {V}_{be} / {R}_{1} ) + ( {V}_{be 1} / {R}_{2} ) \}\end{matrix} \qquad Formula 4$$

In the above Formula, the unit of the reference voltage V_{BGR} is, for example, volt (V). R₃ is a resistance value of the resistor 503, and the unit is, for example, ohm (Ω). The positive temperature coefficient of I_{PTAT0} and the negative temperature coefficient of I_{CTAT0} are set substantially the same by adjusting N, R₁, or R₂.

As illustrated in FIG. 3, since the common-source amplifier is provided in the CTAT current generation unit 400 and feedback control and generation of the CTAT current are simultaneously performed, the minimum operating voltage V_{MIN} is expressed by the following formula.

$${V}_{MIN} = {V}_{be 1} + {V}_{dsp} \qquad Formula 5$$

In the above Formula, V_{dsp} represents the overdrive voltage applied between a drain and a source of the pMOS transistor 431. The unit of V_{MIN} and V_{dsp} are, for example, volt (V).

Assuming that the base-emitter voltage V_{be1} is 0.8 volts (V) and the overdrive voltage V_{d}sp is 0.4 volts (V) under the condition of a predetermined voltage and temperature, the minimum operating voltage V_{MIN} is 1.2 volts (V) according to Formula 5.

Here, in the CTAT current generation unit 400, a circuit having a configuration in which a source follower and a resistor are connected in series is assumed as a comparative example.

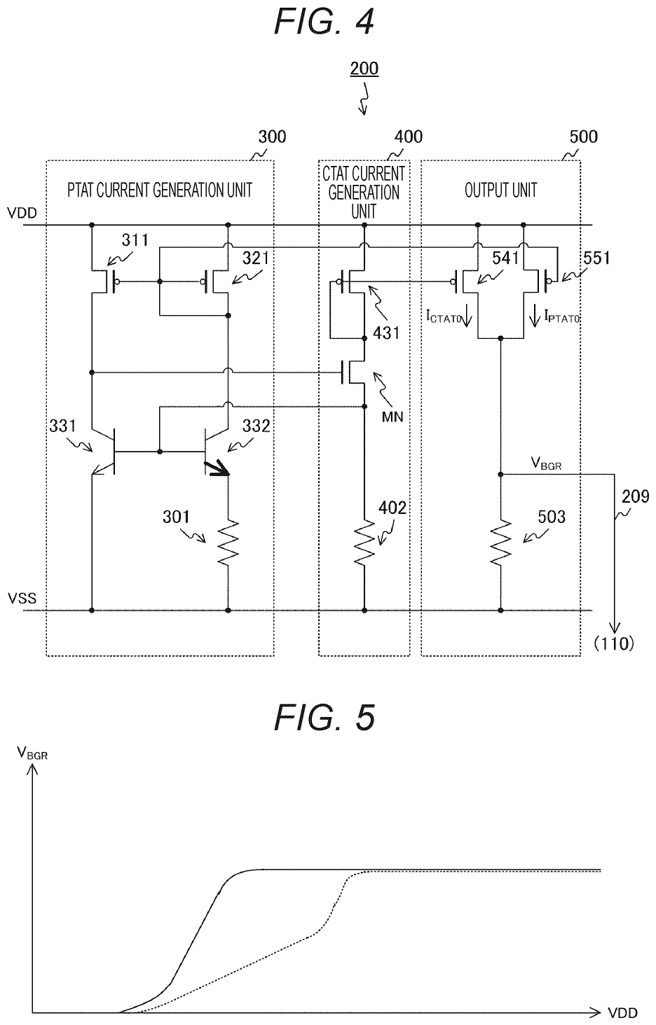

FIG. 4 is a circuit diagram illustrating a configuration example of a reference voltage generation circuit in the comparative example. In this comparative example, an nMOS transistor MN is further disposed in a CTAT current generation unit 400. Furthermore, a pMOS transistor 321 serves as a reference source of a current mirror circuit. A gate of a pMOS transistor 431 is connected to a drain thereof. The nMOS transistor MN is inserted between the pMOS transistor 431 and a resistor 402, and a gate of the nMOS transistor MN is connected to a connection node between a pMOS transistor 311 and a bipolar transistor 331. With this connection configuration, the nMOS transistor MN constitutes a source follower. The circuit in FIG. 4 is a circuit obtained by simplifying the circuit in FIG. 5 of Non-Patent Document 1.

In both the first embodiment and the comparative example, no operational amplifier is used. Therefore, the minimum operating voltage can be lowered as compared with the case of using an operational amplifier. Furthermore, in both the first embodiment and the comparative example, it is not necessary to consider the offset variation of the operational amplifier, and the circuit area can be further reduced as compared with the case of using an operational amplifier. However, in the comparative example in which the source follower is provided in the CTAT current generation unit 400, a minimum operating voltage V_{MIN} is expressed by the following formula.

$${V}_{MIN} = {V}_{be 1} + {V}_{dsp} + {V}_{gsn} \qquad Formula 6$$

In the above formula, V_{gsn} represents a threshold voltage applied between the gate and a source of the nMOS transistor MN.

From Formulas 5 and 6, in the first embodiment in which the common-source amplifier is provided in the CTAT current generation unit 400, the minimum operating voltage is lower than that in the comparative example in which the source follower is provided in the CTAT current generation unit 400.

FIG. 5 is an example of a graph illustrating startup characteristics with respect to the power supply voltage VDD in the first embodiment of the present technology and the comparative example. In FIG. 5, the vertical axis represents the reference voltage V_{BGR} and the horizontal axis represents the power supply voltage VDD. Furthermore, a solid curve indicates the startup characteristic of the first embodiment, and a dotted line indicates the startup characteristic of the comparative example.

As illustrated in FIG. 5, in the comparative example, since the source follower is used, the minimum operating voltage becomes higher than that of the first embodiment. For example, in the comparative example, about 1.8 volts (V) are required as the minimum operating voltage, whereas in the first embodiment, about 1.2 volts (V) is enough.

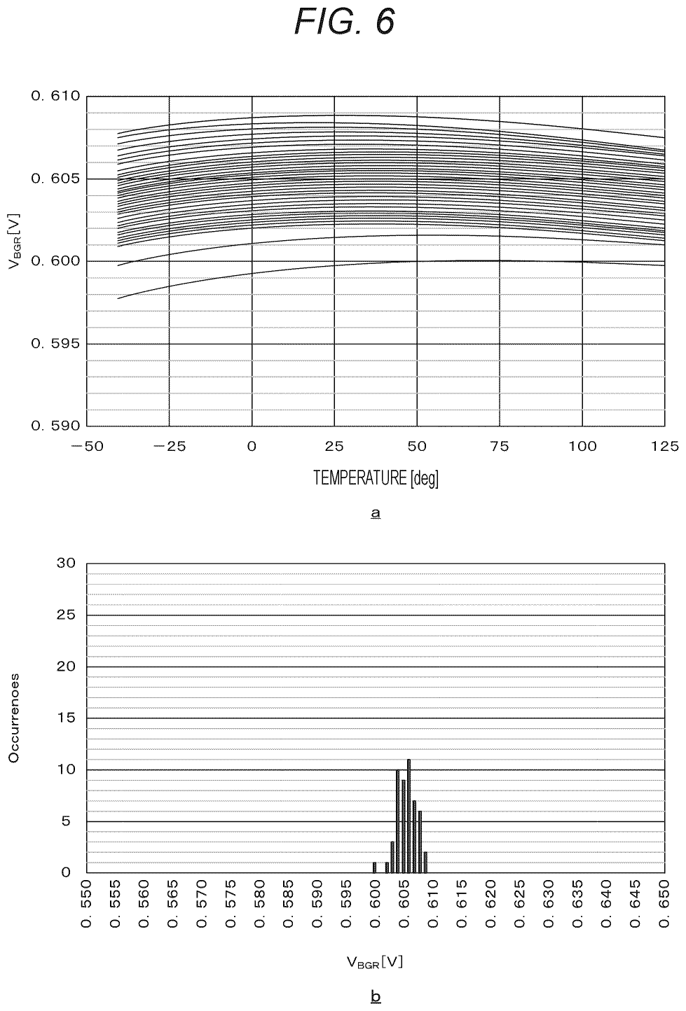

FIG. 6 is a graph illustrating a Monte Carlo simulation result according to the first embodiment of the present technology. In FIG. 6, a illustrates a result of obtaining the temperature dependent characteristic when the power supply voltage is 3 volts (V) in the first embodiment by Monte Carlo simulation. In FIG. 6, b illustrates a histogram of the reference voltage V_{BGR} at a temperature of 27° C.

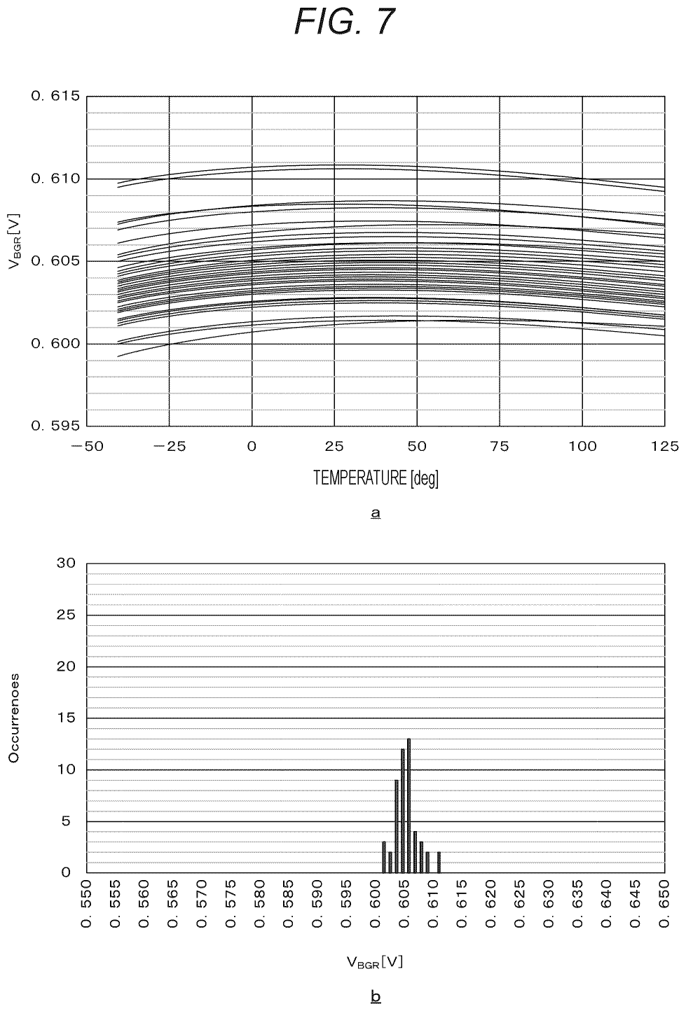

FIG. 7 is a graph illustrating a Monte Carlo simulation result in the comparative example.

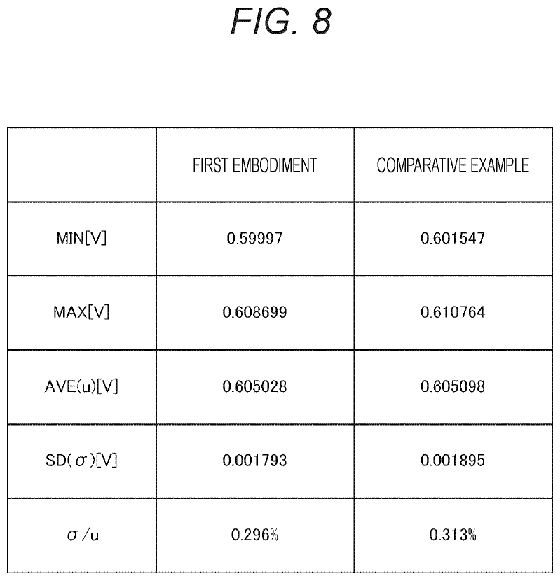

FIG. 8 summarizes the results of FIGS. 6 and 7. “MIN” and “MAX” in FIG. 8 indicate the minimum value and the maximum value of the reference voltage, respectively. “AVE” and “SD” indicate the average value and standard deviation of the reference voltage, respectively.

As illustrated in FIGS. 5 to 8, MIN, MAX, AVE, SD, and σ/μ are equivalent between the first embodiment and the comparative example. However, in the first embodiment, the minimum operating voltage is 1.2 volts or the like, and operation is possible at a lower voltage than in the comparative example in which the minimum operating voltage is 1.8 volts or the like.

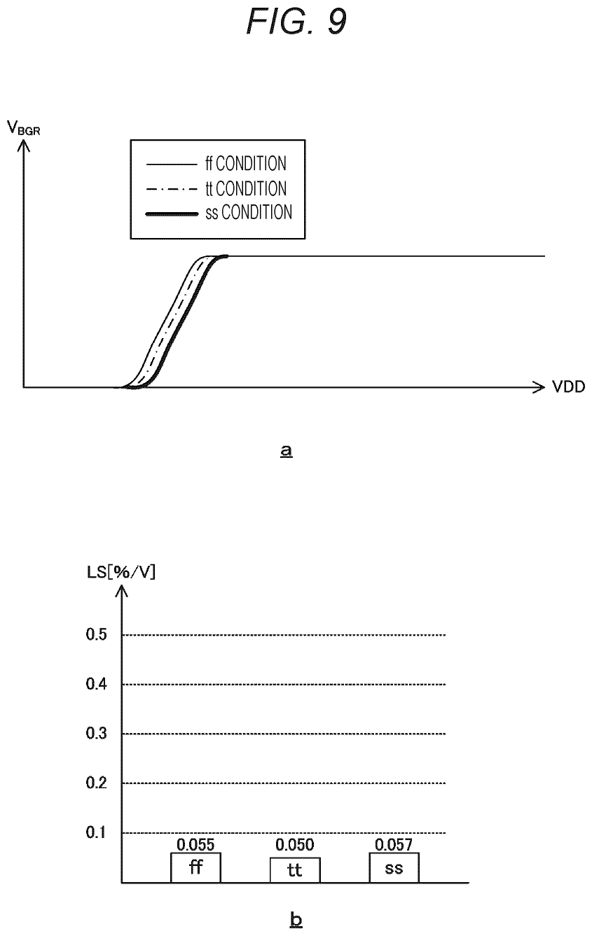

FIG. 9 is a graph illustrating an example of a power supply voltage-dependent characteristic according to the first embodiment of the present technology. a in FIG. 9 illustrates the power supply voltage-dependent characteristic. Furthermore, in FIG. 9. the vertical axis of a indicates the reference voltage V_{BG}, and the horizontal axis of a indicates the power supply voltage VDD. The thin solid line indicates the temperature dependent characteristic of an ff condition in which thresholds of the pMOS and the nMOS are low. The thick solid line indicates the temperature dependent characteristic of an ss condition in which thresholds of the pMOS and the nMOS are high. The alternate long and short dash line indicates a tt condition in which thresholds of the pMOS and the nMOS are intermediate values. In FIG. 9, b represents line sensitivity (LS) to a power supply line in the range from the minimum operating voltage to 3 volts (V).

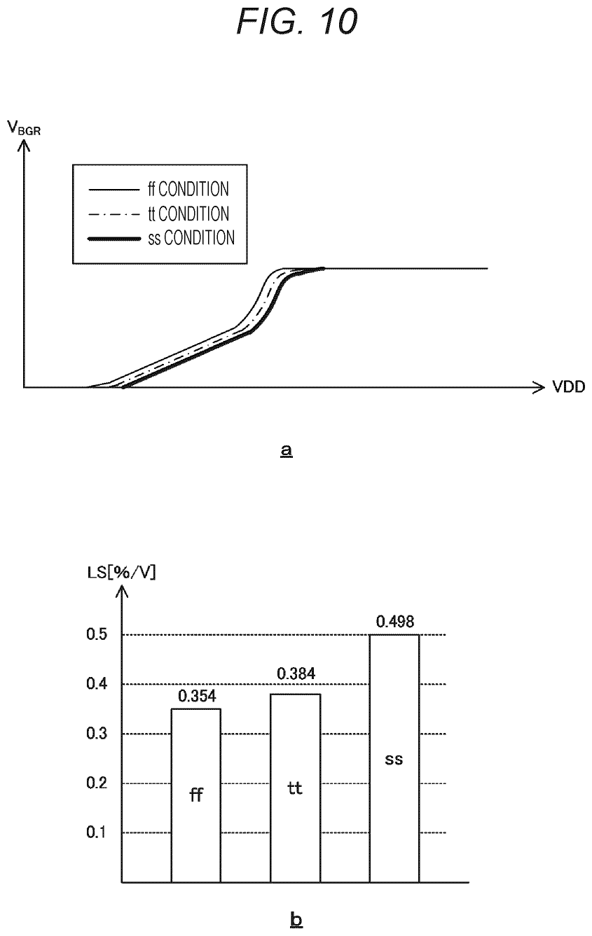

FIG. 10 is a graph illustrating an example of a power supply voltage-dependent characteristic in the comparative example.

As illustrated in FIGS. 9 and 10, in the first embodiment, the minimum operating voltage can be made lower than that in the comparative example under each of the ss, ff, and tt conditions. Furthermore, the dependency on the direct-current power supply voltage in the first embodiment is significantly improved as compared with the comparative example.

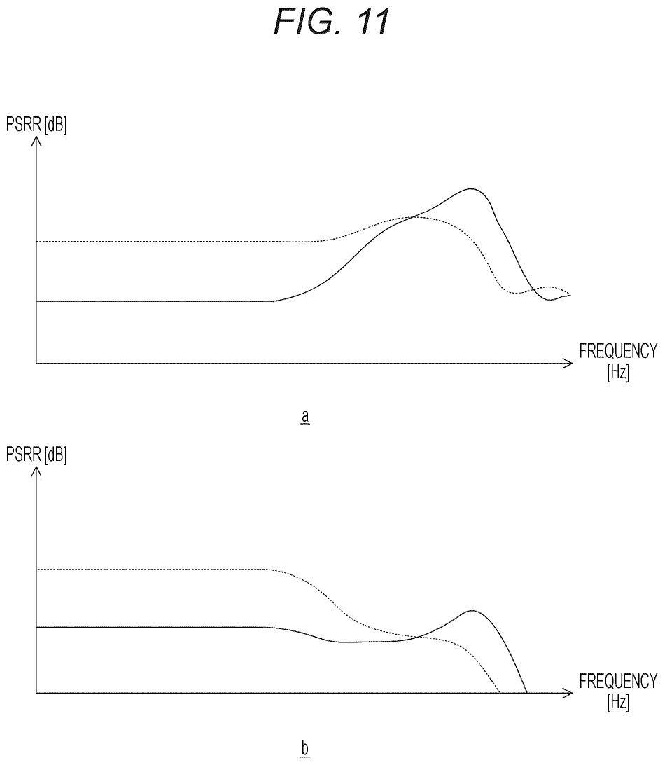

FIG. 11 illustrates graphs each illustrating an example of a PSRR characteristic at a same power supply voltage in the first embodiment of the present technology and the comparative example. In FIG. 11, a illustrates an example of the PSRR characteristic when the capacitance of 50 picofarads (pF) is added to the reference voltage generation circuit. In FIG. 11, b illustrates an example of the PSRR characteristic when a resistance of 100 kilo-ohms (kΩ) and a low-pass filter are applied to the reference voltage generation circuit. In each of a and b of FIG. 11, the vertical axis represents a PSRR, and the horizontal axis represents frequency. Furthermore, the solid curve indicates the characteristic of the first embodiment, and the dotted line indicates the characteristic of the comparative example.

As illustrated in FIG. 11, in the first embodiment, since the amplifier is of the common-source type, a high gain can be obtained from a lower power supply voltage, the PSRR in a low frequency band is lower than that in the comparative example, and a preferable characteristic is obtained. In contrast, even though the high gain is obtained, in a high frequency band, deterioration of the PSRR characteristic starts from a frequency lower than that in the comparative example, which may be avoided by a countermeasure such as installing a low pass filter.

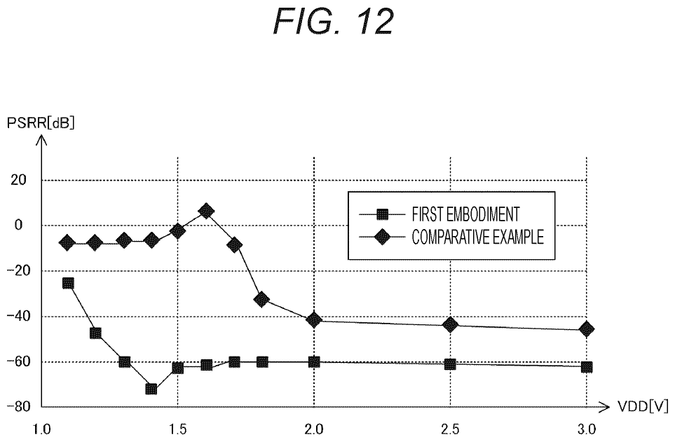

FIG. 12 is a graph illustrating an example of a power supply voltage-dependent characteristic of a PSRR characteristic in the low frequency band in each of the first embodiment of the present technology and the comparative example. In FIG. 12, the vertical axis represents the PSRR, and the horizontal axis represents the power supply voltage VDD. As illustrated in FIG. 12, in the first embodiment, the PSRR is lower than that in the comparative example.

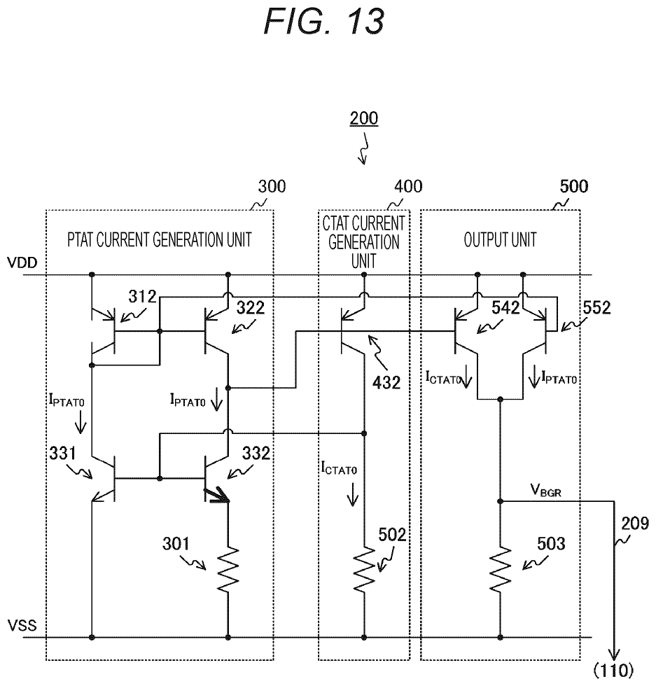

Note that although pMOS transistors are used as the current sources such as the current source 310, PNP bipolar transistors can also be used as illustrated in FIG. 13. In this case, bipolar transistors 312, 322, 432, 542, and 552 are used instead of the pMOS transistors 311, 321, 431, 541, and 551.

As described above, according to the first embodiment of the present technology, since the CTAT current is generated by the common-source pMOS transistor 431 and the resistor 402, the minimum operating voltage can be reduced as compared with the case of using the source follower.

### 2. Second Embodiment

In the first embodiment described above, the pMOS transistors 311, 321, 431, 541, and 551 used as the current sources are connected to the power supply voltage VDD, but they can also be connected to the ground voltage VSS. A reference voltage generation circuit 200 of a second embodiment is different from that of the first embodiment in that current sources are disposed on a ground side.

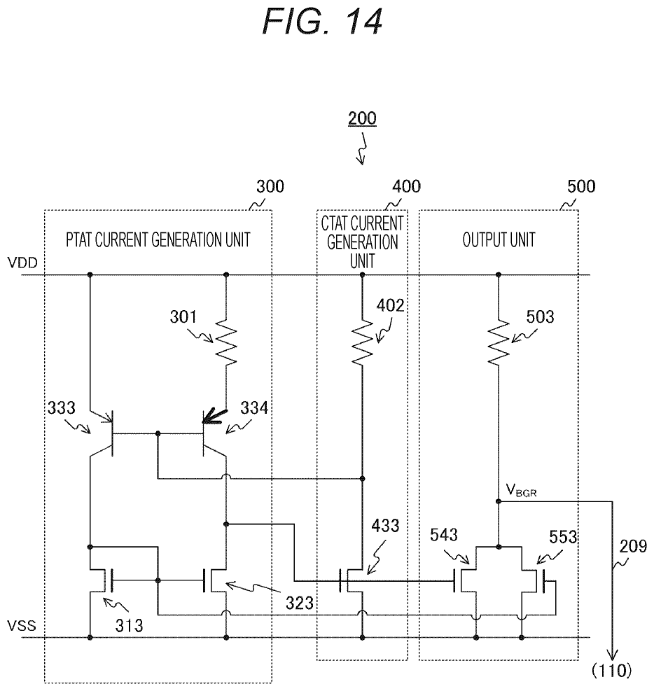

FIG. 14 is a circuit diagram illustrating a configuration example of the reference voltage generation circuit 200 according to the second embodiment of the present technology. In the reference voltage generation circuit 200 of the second embodiment, nMOS transistors 313, 323, 433, 543, and 553 are used instead of the pMOS transistors 311, 321, 431, 541, and 551, and are disposed on the ground side. Furthermore, PNP bipolar transistors 333 and 334 are used instead of the NPN bipolar transistors 331 and 332. A reference voltage V_{B}m is a value obtained by subtracting R₃(I_{PTAT0}+I_{CTAT0}) from a power supply voltage VDD.

As described above, according to the second embodiment of the present technology, since the current sources, that is, the nMOS transistors 313, 323, 433, 543, and 553 are arranged on the ground side, it is possible to supply the reference voltage having a value obtained by subtracting R₃(I_{PTAT0}+I_{CTAT0}) from the power supply voltage VDD.

### 3. Third Embodiment

In the first embodiment described above, it is assumed that the base current is negligible. However, in a recent miniaturized complementary MOS (CMOS) process, a parasitic bipolar transistor by well coupling is often used, and thus, a current amplification factor becomes small, and an influence of a base current cannot be ignored in some cases. A reference voltage generation circuit 200 of a third embodiment is different from that of the first embodiment in that a base current is canceled by adding a current source.

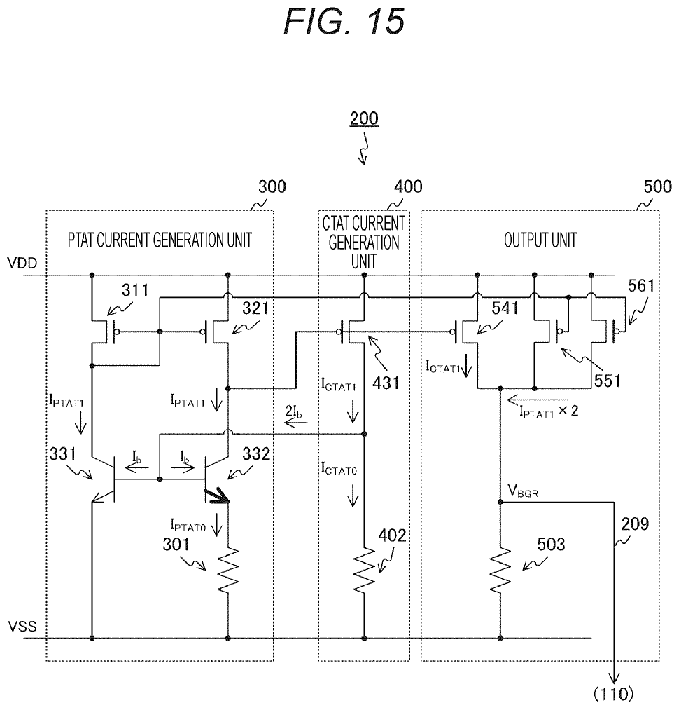

FIG. 15 is a circuit diagram illustrating a configuration example of a reference voltage generation circuit 200 according to a third embodiment of the present technology. The reference voltage generation circuit 200 of the third embodiment is different from that of the first embodiment in that a pMOS transistor 561 is further arranged in an output unit 500.

The pMOS transistor 561 is connected in parallel with pMOS transistors 541 and 551 between a power supply voltage VDD and a resistor 503. Furthermore, it is assumed that the size of the pMOS transistor 561 is the same as each of those of pMOS transistors 311, 321 and the pMOS transistor 551. Furthermore, a gate of the pMOS transistor 561 is connected to a gate of the pMOS transistor 311. Note that the pMOS transistor 561 is an example of a sixth current source recited in claims.

In a PTAT current generation unit 300, assuming that the current amplification factor is β for each of bipolar transistors 331 and 332, a collector current is β times as large as a base current I_{b}. In a case where the base currents of the bipolar transistors 331 and 332 substantially coincide with each other, assuming that the current flowing through a resistor 301 is I_{PTAT0}, I_{PTAT1}, which is the collector current of each of the bipolar transistors 331 and 332 is expressed by the following formula.

$$\begin{matrix}{I}_{PTAT 1} = β \times {I}_{b} \\ = {I}_{PTAT 0} - {I}_{b}\end{matrix} \qquad Formula 7$$

Next, in the CTAT current generation unit 400, a current obtained by adding the base currents of the bipolar transistors 331 and 332 flows. Therefore, assuming that the current supplied by the pMOS transistor is I_{CTAT1} and the current flowing through a resistor 402 is I_{CTAT0}, I_{CTAT1} is expressed by the following formula.

$${I}_{CTAT 1} = {I}_{CTAT 0} + 2 {I}_{b} \qquad Formula 8$$

If the PTAT current I_{PTAT1} and the CTAT current I_{CTAT1} are taken out at a mirror ratio of one time, in the case of the first embodiment without the pMOS transistor 561, the reference voltage V_{BGR} is expressed by the following formula on the basis of Formulas 7 and 8.

$$\begin{matrix}{V}_{BGR} = {R}_{3} ( {I}_{PTAT 1} + {I}_{CTAT 1} ) \\ = {R}_{3} ( {I}_{PTAT 0} + {I}_{CTAT 0} + {I}_{b} )\end{matrix} \qquad Formula 9$$

As illustrated in Formula 9, in the first embodiment, in a case where the current amplification factor is small, the term of the base current I_{b} remains. Therefore, if the current amplification factor β increases or decreases due to variations in the process of the bipolar transistors 331 and 332, the absolute value of the reference voltage V_{BGR} and the temperature dependency greatly fluctuate.

Therefore, in the third embodiment, the pMOS transistor 561 is added in parallel to set the mirror ratio to twice. As a result, the reference voltage V_{BGR} of the third embodiment becomes a value of the following formula.

$$\begin{matrix}{V}_{BGR} = {R}_{3} ( 2 \times {I}_{PTAT 1} + {I}_{CTAT 1} ) \\ = {R}_{3} ( 2 \times {I}_{PTAT 0} + {I}_{CTAT 0} )\end{matrix} \qquad Formula 10$$

From Formula 10, the base current I_{b} can be canceled. The temperature coefficient of I_{PTAT0} is set to ½ of the temperature coefficient of I_{CTAT0}.

Here, since the number of bipolar transistors connected to the output of the CTAT current generation unit 400 is two, the mirror ratio of the PTAT current is set to twice. However, the mirror ratio is not limited to twice. It is only required to set the value of the mirror ratio to an appropriate value according to the number of bipolar transistors.

As described above, in the third embodiment, compensation of the base current I_{b} can be realized very simply and easily only by changing the mirror ratio of a current mirror circuit, and it is possible to achieve both reduction in voltage and reduction in area.

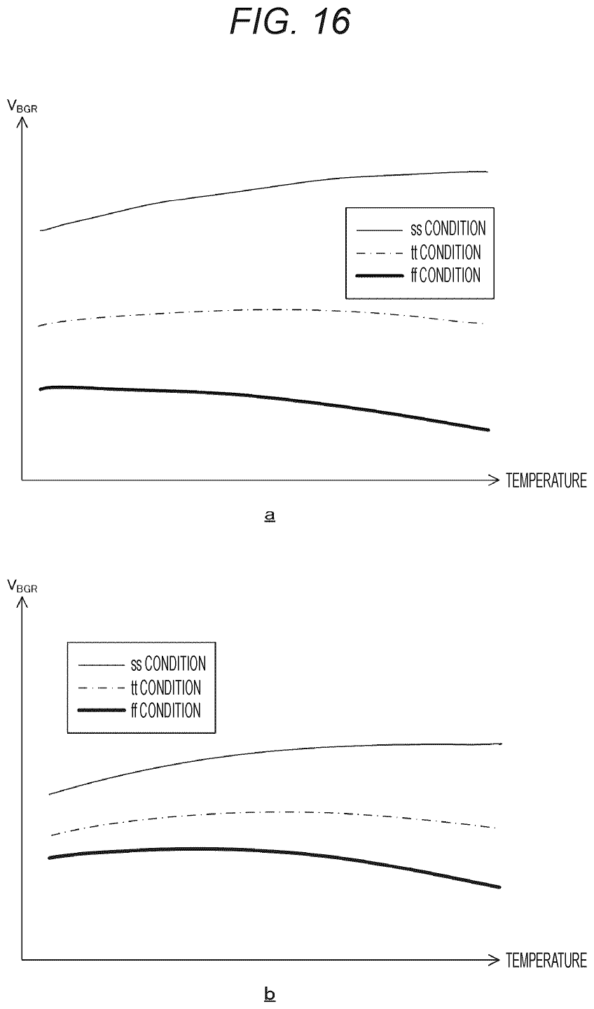

FIG. 16 is a diagram for explaining effects according to the third embodiment of the present technology. In FIG. 16, a is a graph illustrating a temperature dependent characteristic of the reference voltage V_{BGR} in the first embodiment when the base current remains. In FIG. 16, b is a graph illustrating a temperature dependent characteristic of the reference voltage V_{BGR} in the third embodiment. In each of a and b of FIG. 16, the vertical axis represents the reference voltage V_{BG}, and the horizontal axis represents the absolute temperature. The thin solid line indicates the temperature dependent characteristic of the ss condition. The thick solid line indicates the temperature dependent characteristic of the ff condition. The alternate long and short dash line indicates the tt condition.

As illustrated in a and b of FIG. 16, in the third embodiment, it is possible to reduce a variation in the absolute value of the reference voltage V_{BG} and a variation in the temperature dependency of the reference voltage V_{BG} with respect to the absolute variation of the process, as compared with the first embodiment.

Note that the second embodiment can be applied to the third embodiment.

As described above, according to the third embodiment of the present technology, since the pMOS transistor 561 is added, the base current can be canceled. With this arrangement, fluctuations in the absolute value and temperature dependency of the reference voltage V_{BGR} can be reduced.

### [Modification]

In the third embodiment described above, the base current is canceled by adding the current source, but the base current can also be canceled by adding a resistor. A reference voltage generation circuit 200 of a modification of the third embodiment is different from that of the third embodiment in that a base current is canceled by adding a resistor.

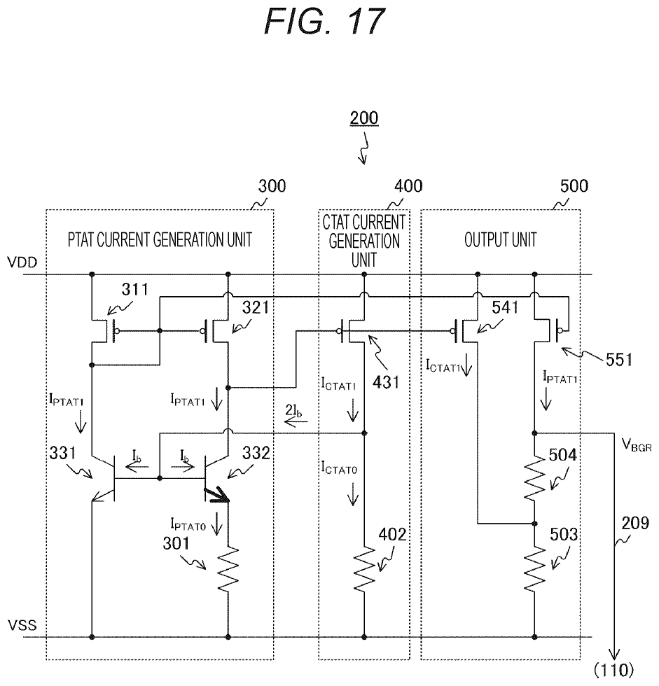

FIG. 17 is a circuit diagram illustrating a configuration example of the reference voltage generation circuit 200 in the modification of the third embodiment of the present technology. The reference voltage generation circuit 200 of the modification of the third embodiment is different from that of the third embodiment in that a resistor 504 is arranged instead of the pMOS transistor 561.

The resistor 504 is inserted between a pMOS transistor 551 and a resistor 503. Furthermore, a connection node between the resistors 503 and 504 is connected to a pMOS transistor 541, and the voltage of a connection node between the pMOS transistor 551 and the resistor 504 is output as a reference voltage V_{BGR}.

In a case where the resistance value of the resistor 504 is R₃×α (α is an integer), the reference voltage V_{BGR} is expressed by the following formula.

$$\begin{matrix}{V}_{BGR} = {R}_{3} \times ( {I}_{PTAT 1} + {I}_{CTAT 1} ) + {R}_{3} \times α \times {I}_{PTAT 1} \\ = {R}_{3} \times ( {I}_{PTAT 0} + {I}_{CTAT 0} + {I}_{b} ) + {R}_{3} \times α \times ( {I}_{PTAT 0} - {I}_{b} ) \\ = {R}_{3} \times \{ ( 1 + α ) {I}_{PTAT 0} + {I}_{CTAT 0} ) \} + {R}_{3} \times ( 1 - α ) {I}_{b}\end{matrix} \qquad Formula 11$$

By setting α to 1 on the basis of Formula 11, the base current can be canceled. The temperature coefficient of I_{PTAT0} is set to 1/(1+a) of the temperature coefficient of I_{CTAT0}.

However, in this method, since the resistor 504 has the predetermined resistance ratio α, it is necessary to note that implementation of a trimming function is difficult.

Note that the second embodiment can be applied to the modification of the third embodiment.

As described above, according to the modification of the third embodiment of the present technology, since the resistor 504 is inserted between the pMOS transistor 551 and the resistor 503, the base current can be canceled.

### 4. Fourth Embodiment

In the first embodiment described above, it is assumed that the base current is negligible. However, in a recent miniaturized CMOS process, the current amplification factor becomes small, and the influence of a base current cannot be ignored in some cases. A reference voltage generation circuit 200 of a fourth embodiment is different from that of the first embodiment in that a base current is canceled by adding a circuit for detecting the base current.

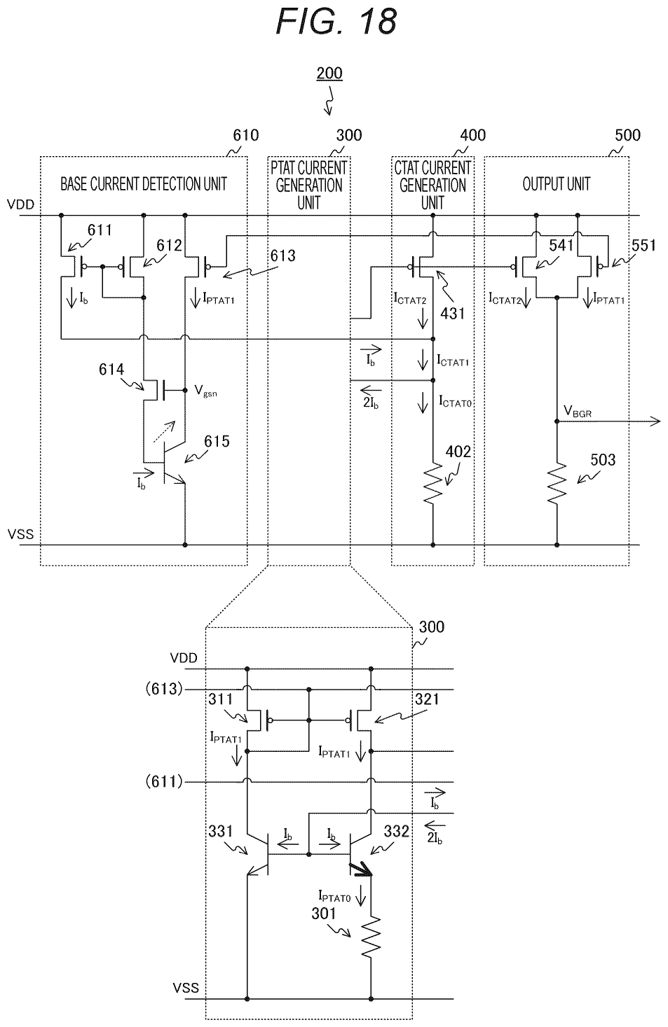

FIG. 18 is a circuit diagram illustrating a configuration example of the reference voltage generation circuit 200 according to the fourth embodiment of the present technology. The reference voltage generation circuit 200 of the fourth embodiment is different from that of the first embodiment in further including a base current detection unit 610.

The base current detection unit 610 detects a base current and corrects a CTAT current with the base current. The base current detection unit 610 includes pMOS transistors 611 to 613, an nMOS transistor 614, and a bipolar transistor 615.

The pMOS transistors 611 to 613 are connected in parallel to a power supply voltage VDD. Furthermore, a drain of the pMOS transistor 611 is connected to a connection node between a pMOS transistor 431 and a resistor 402. Furthermore, a gate of the pMOS transistor 612 is connected to a drain thereof and a gate of the pMOS transistor 611.

The nMOS transistor 614 is inserted between the pMOS transistor 612 and a base of the bipolar transistor 615. The bipolar transistor 615 is inserted between the pMOS transistor 613 and a ground voltage VSS.

Furthermore, a gate of the nMOS transistor 614 is connected to a connection node between the pMOS transistor 613 and the bipolar transistor 615.

The pMOS transistors 611 and 612 constitute a current mirror circuit using the pMOS transistor 612 as a reference source, and the mirror ratio is set to one time. The pMOS transistor 611 replicates a base current I_{b} of the pMOS transistor 612 and supplies the replicated base current I_{b} to a CTAT current generation unit 400. This base current I_{b} is added to a CTAT current I_{CTAT2} supplied by the pMOS transistor 431. On the basis of Formula 8, I_{CTAT2} is expressed by the following formula.

$$\begin{matrix}{I}_{CTAT 2} = {I}_{CTAT 1} - {I}_{b} \\ = {I}_{CTAT 0} + {I}_{b}\end{matrix} \qquad Formula 12$$

Furthermore, the pMOS transistors 613 and 311 constitute a current mirror circuit using the pMOS transistor 311 as a reference source, and the mirror ratio is one time. The pMOS transistor 613 replicates I_{PTAT1} supplied by the pMOS transistor 311 and supplies the replicated I_{PTAT1} to the bipolar transistor 615.

An output unit 500 adds the PTAT current I_{PTAT1} and the CTAT current I_{CTAT2}. Therefore, a reference voltage V_{BGR} is expressed by the following formula on the basis of Formulas 7 and 12.

$$\begin{matrix}{V}_{BGR} = {R}_{3} ( {I}_{PTAT 1} + {I}_{CTAT 2} ) \\ = {R}_{3} ( {I}_{PTAT 0} + {I}_{CTAT 0} )\end{matrix} \qquad Formula 13$$

From Formula 13, the base current can be canceled.

In the circuit of FIG. 18, there is a possibility that the minimum operating voltage increases due to vertical stacking of the bipolar transistor 615 and the nMOS transistor 614, but this problem can be alleviated by using the nMOS transistor 614 having a small threshold voltage.

Note that the second embodiment can be applied to the fourth embodiment.

As described above, according to the fourth embodiment of the present technology, since the base current detection unit 610 detects the base current and corrects the CTAT current, the base current can be canceled.

### [Modification]

In the above-described fourth embodiment, the base current I_{b} is added to the CTAT current I_{CTAT2}, but the base current I_{b} can also be subtracted from the current flowing through the resistor 503. A reference voltage generation circuit 200 according to a modification of the fourth embodiment is different from that of the fourth embodiment in that a base current I_{b} is subtracted from the current flowing through a resistor 503.

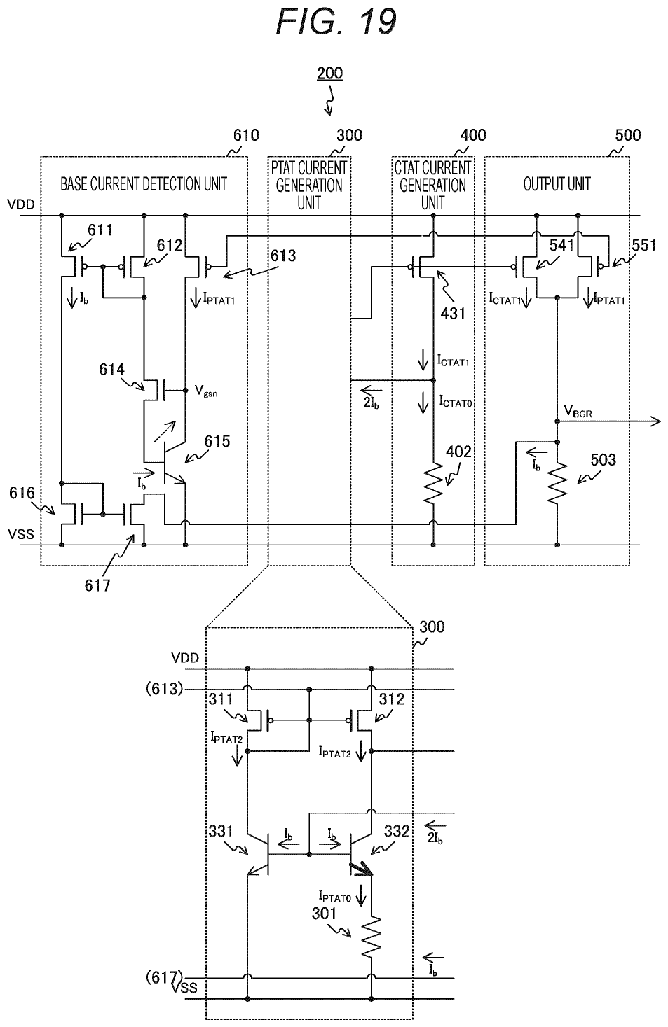

FIG. 19 is a circuit diagram illustrating a configuration example of the reference voltage generation circuit 200 in the modification of the fourth embodiment of the present technology. The reference voltage generation circuit 200 according to the modification of the fourth embodiment is different from that of the fourth embodiment in that nMOS transistors 616 and 617 are further provided in a base current detection unit 610. Furthermore, a pMOS transistor 611 according to the modification of the fourth embodiment is different from that of the fourth embodiment in that the pMOS transistor 611 is not connected to a CTAT current generation unit 400.

The nMOS transistor 616 is inserted between the pMOS transistor 611 and a ground voltage VSS. A gate of the nMOS transistor 616 is connected to a drain thereof and a gate of the nMOS transistor 617. The nMOS transistor 617 is inserted between a connection node between a pMOS transistor 541 and a resistor 503 and a ground voltage VSS.

The nMOS transistors 616 and 617 constitute a current mirror circuit using the nMOS transistor 616 as a reference source, and a mirror ratio thereof is set to one time. The base current I_{b} supplied by the pMOS transistor 611 is replicated by the nMOS transistor 617. Since the nMOS transistor 617 is connected to the connection node between the pMOS transistor 541 and the resistor 503, the base current I_{b} is subtracted from the current flowing through the resistor 503. By subtraction of the base current I_{b}, a reference voltage V_{BGR} becomes a value expressed by the following formula.

$$\begin{matrix}{V}_{BGR} = {R}_{3} ( {I}_{PTAT 1} + {I}_{CTAT 1} - {I}_{b} ) \\ = {R}_{3} ( {I}_{PTAT 0} + {I}_{CTAT 0} )\end{matrix} \qquad Formula 14$$

From Formula 14, the base current can be canceled.

Note that the second embodiment can be applied to the modification of the fourth embodiment.

As described above, according to the fourth embodiment of the present technology, since the base current detection unit 610 detects the base current and subtracts the detected base current from the current flowing through the resistor 503, the base current can be canceled.

### 5. Fifth Embodiment

In the above-described fourth embodiment, the base current detection unit 610 corrects the base current remaining in the sum of the PTAT current and the CTAT current in the output unit 500, but instead, the base current error for only the PTAT current can be corrected. A reference voltage generation circuit 200 according to a fifth embodiment is different from that in the fourth embodiment in that a base current detection unit 610 corrects a PTAT current.

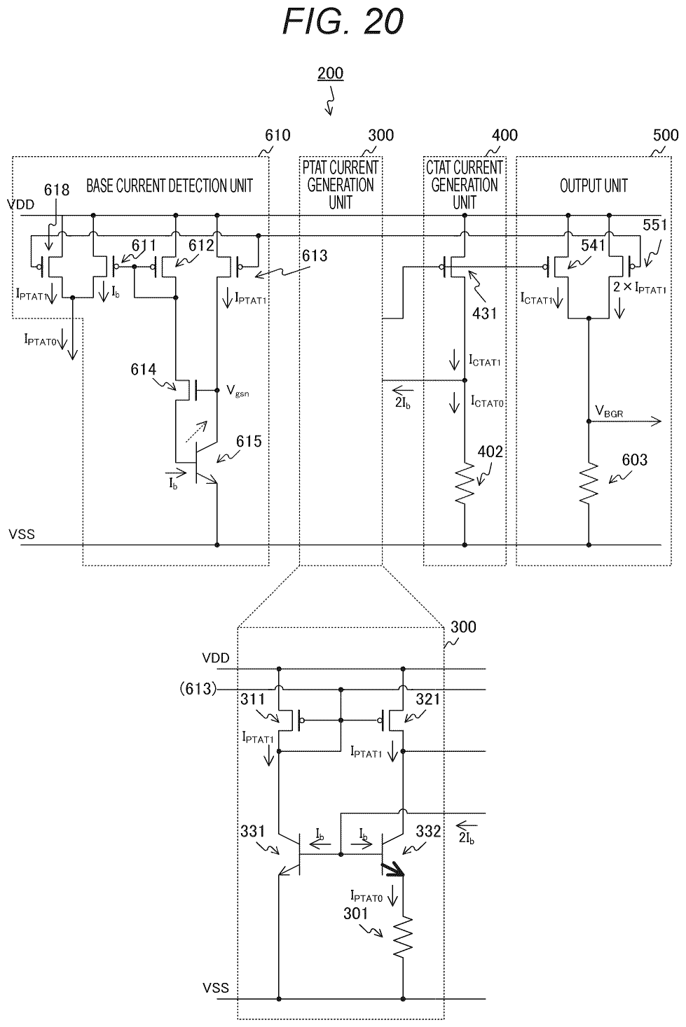

FIG. 20 is a circuit diagram illustrating a configuration example of a reference voltage generation circuit 200 according to the fifth embodiment of the present technology. The reference voltage generation circuit 200 of the fifth embodiment is different from that of the fourth embodiment in further including a pMOS transistor 618. Furthermore, a pMOS transistor 611 according to a modification of the fifth embodiment is different from that of the fourth embodiment in that the pMOS transistor 611 is not connected to a CTAT current generation unit 400.

A gate of a pMOS transistor 311 is also connected to a gate of the pMOS transistor 618, and a source of the pMOS transistor 618 is connected to a power supply voltage VDD. Furthermore, a drain of the pMOS transistor 618 is connected to a drain of the pMOS transistor 611.

It is assumed that the pMOS transistors 618 and 311 constitute a current mirror circuit using the pMOS transistor 311 as a reference source, and the mirror ratio is one time. The pMOS transistor 618 replicates a PTAT current I_{PTAT1} and supplies the replicated PTAT current I_{PTAT1}. A PTAT current I_{PTAT0} obtained by adding I_{PTAT1} and a base current I_{b} (in other words, correcting I_{PTAT1} with I_{b}) is output to the outside from a connection node between the pMOS transistors 611 and 618. For example, when a temperature detection circuit such as a temperature sensor is mounted on a same semiconductor integrated circuit, the PTAT current I_{PTAT0} is used in the circuit.

Furthermore, the pMOS transistor 311 and a pMOS transistor 551 constitute a current mirror circuit using the pMOS transistor 311 as a reference source, and the mirror ratio is twice. By changing the mirror ratio, the base current is canceled similarly to the third embodiment.

Note that the second embodiment can be applied to the fifth embodiment.

As described above, according to the fifth embodiment of the present technology, since the base current detection unit 610 corrects the PTAT current I_{PTAT1} and outputs the corrected PTAT current I_{PTAT1}, a temperature detection circuit or the like can be realized by using the current.

### 6. Sixth Embodiment

In the first embodiment described above, the output unit 500 outputs the reference voltage V_{BGR}, but can further output a reference current that does not depend on the absolute temperature. A reference voltage generation circuit 200 according to a sixth embodiment is different from that in the sixth embodiment in further outputting a reference current.

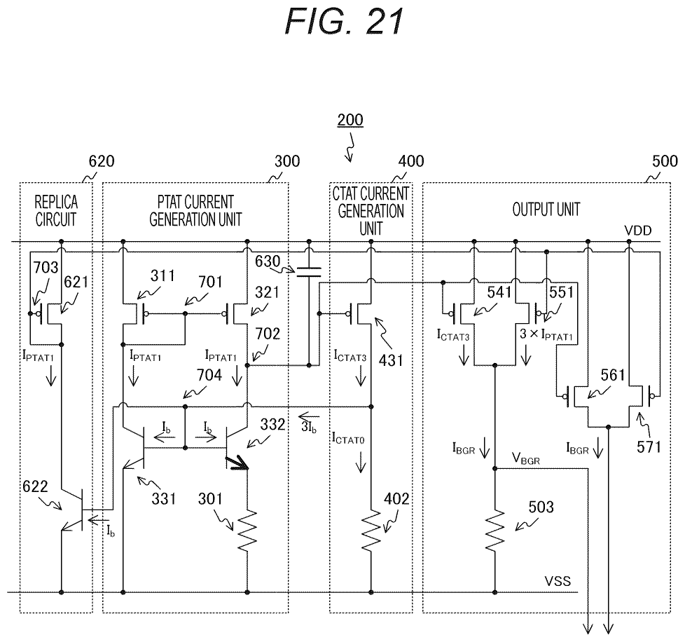

FIG. 21 is a circuit diagram illustrating a configuration example of the reference voltage generation circuit 200 according to the sixth embodiment of the present technology. The reference voltage generation circuit 200 of the sixth embodiment includes a replica circuit 620, a phase compensation capacitor 630, and pMOS transistors 561 and 571. The replica circuit 620 includes a pMOS transistor 621 and a bipolar transistor 622.

The replica circuit 620 generates a PTAT current I_{PTAT1} by a circuit equivalent to a pMOS transistor 311 and a bipolar transistor 331. The pMOS transistor 621 and the bipolar transistor 622 in the replica circuit 620 are connected in series between a power supply voltage VDD and a ground voltage VSS. A base of the bipolar transistor 622 is connected to a base of the bipolar transistor 331. A drain of the pMOS transistor 621 is connected to a gate thereof and a gate of the pMOS transistor 571.

Furthermore, in an output unit 500, the pMOS transistors 561 and 571 are connected in parallel to the power supply voltage VDD. A gate of the pMOS transistor 561 is connected to a gate of a pMOS transistor 431. Drains of the pMOS transistors 561 and 571 are connected, and a current obtained by adding a PTAT current and a CTAT current is output as a reference current I_{BGR} from a connection node between the drains of the pMOS transistors 561 and 571.

The phase compensation capacitor 630 is inserted between the gate of the pMOS transistor 431 and the power supply voltage VDD.

Furthermore, since a base current also flows through the bipolar transistor 622, a CTAT current I_{CTAT3} generated by a CTAT current generation unit 400 is expressed by the following formula.

$${I}_{CTAT 3} = {I}_{CTAT 0} + 3 {I}_{b} \qquad Formula 15$$

In order to cancel the base current in Formula 15, the mirror ratio of a current mirror circuit including the pMOS transistor 311 and a pMOS transistor 551 is set to three times. Therefore, a reference voltage V_{B}GR has a value expressed by the following formula.

$$\begin{matrix}{V}_{BGR} = {R}_{3} ( 3 {I}_{PTAT 1} + {I}_{CTAT 3} ) \\ = {R}_{3} ( 3 {I}_{PTAT 0} + {I}_{CTAT 0} )\end{matrix} \qquad Formula 16$$

In the above formula, the temperature coefficient of I_{PTAT0} is set to ⅓ of the temperature coefficient of I_{CTAT0}.

In the case of expanding the output, there is also a method in which unlike in FIG. 21, no replica circuit 620 is provided, and signal lines are drawn from nodes 701 and 702 in the current mirror circuit to add a pMOS transistor in the output unit 500. Here, the node 701 is a gate and a drain of the pMOS transistor 311, and the node 702 is the gate of the pMOS transistor 431.

However, in the reference voltage generation circuit 200, a PTAT current generation unit 300 and the CTAT current generation unit 400 are operated as a two-stage operational amplifier, and the phase compensation capacitor 630 is connected to the node 702 corresponding to an input of the CTAT current generation unit 400 so that a first pole is located at the node 702. Furthermore, the node 701 of the PTAT current generation unit 300 is a node forming a second pole frequency.

For this reason, if there is no replica circuit 620, a gate connection is added to the node 701 when the output is expanded, and the capacitance load becomes heavy and affects the stability of the circuit, which can be coped with by increasing the capacitance value of the phase compensation capacitor 630 of the node 702 to reduce the band; however, the impact on the circuit area is large. This is a price of realizing low-voltage operation, but can be easily avoided by adding the replica circuit 620 as illustrated in FIG. 21.

In FIG. 21, a signal line is drawn out from a node 704 of the gate of the bipolar transistor 331, and the bipolar transistor 622 using the bipolar transistor 331 as a reference source is added. Furthermore, the replica circuit 620 extracts a PTAT current, and a gate voltage for expanding the PTAT current is extracted from a node 703, which is a gate of the pMOS transistor 621.

In this configuration, the impedance of the node 704 is parallel to the input resistance of the base of the bipolar transistor 331 and the resistor 402, and the value thereof is relatively low, so that the influence on the stability is low.

Note that the second embodiment can be applied to the sixth embodiment. Furthermore, the modification of the third embodiment can also be applied. In this case, it is only required to insert the resistor 504 between a resistor 503 and the pMOS transistor 551, or to divide the resistor 503. Furthermore, the fourth and fifth embodiments can also be applied to the sixth embodiment.

Furthermore, in FIG. 21, the phase compensation capacitor 630 is inserted between the node 702 and the power supply voltage VDD, but mirror compensation in which one of the two phase compensation capacitors is connected to the node 702 and the other is connected to the node 704 may be used. Mirror compensation can reduce the capacitance value of the phase compensation capacitor. However, it should be noted that in this case, the PSRR characteristic is sacrificed.

As described above, according to the sixth embodiment of the present technology, since the replica circuit 620 is provided, the stability of the circuit can be improved when the output is expanded.

### 7. Seventh Embodiment

In the first embodiment described above, the reference voltage V_{BGR} is generated without using the phase compensation capacitor, but with this configuration, there is a possibility that the circuit becomes unstable. A reference voltage generation circuit 200 according to a seventh embodiment is different from that in the first embodiment in that a phase compensation capacitor is added.

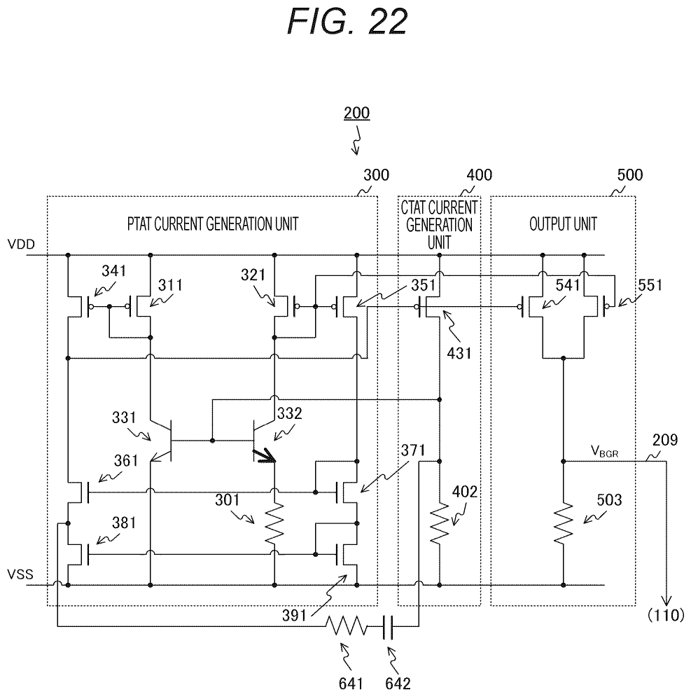

FIG. 22 is a circuit diagram illustrating a configuration example of the reference voltage generation circuit 200 according to the seventh embodiment of the present technology. The reference voltage generation circuit 200 of the seventh embodiment further includes pMOS transistors 341 and 351, nMOS transistors 361, 371, 381, and 391, a resistor 641, and a phase compensation capacitor 642.

The pMOS transistors 341 and 351 are connected in parallel to a power supply voltage VDD. The pMOS transistor 341 and a pMOS transistor 311 constitute a current mirror circuit using the pMOS transistor 311 as a reference source. The pMOS transistor 351 and a pMOS transistor 321 constitute a current mirror circuit using the pMOS transistor 321 as a reference source.

The nMOS transistors 361 and 381 are connected in series between the pMOS transistor 341 and a ground voltage VSS. A connection node between the pMOS transistor 341 and the nMOS transistor 361 is connected to a CTAT current generation unit 400. The nMOS transistors 371 and 391 are connected in series between the pMOS transistor 351 and the ground voltage VSS. Furthermore, a gate of the nMOS transistor 371 is connected to a drain thereof and a gate of the nMOS transistor 361. A gate of the nMOS transistor 391 is connected to a drain thereof and a gate of the nMOS transistor 381.

With the addition of the pMOS transistors 341 and 351 and the nMOS transistors 361, 371, 381, and 391, a PTAT current generation unit 300 constitutes a folded-back differential circuit.

The resistor 641 and the phase compensation capacitor 642 are connected in series between a connection node between the cascode-connected nMOS transistors 361 and 381 and a connection node between a pMOS transistor 431 and a resistor 402.

The potential of the connection node between the cascode-connected nMOS transistors 361 and 381 is determined with reference to the ground. A similar thing applies to the connection node between the pMOS transistor 431 and the resistor 402. By inserting the phase compensation capacitor 642 between these nodes, it is possible to reduce the capacitance value of the phase compensation capacitor 642 required when sufficient phase compensation is performed as compared with a case where the phase compensation capacitor is inserted at another location. Furthermore, resistance to power supply noise is improved, and both ensuring stability and maintaining the PSRR characteristic can be achieved. However, since there is a possibility that the minimum operating voltage increases or varies, and noise increases, it is necessary to optimize the design by determining a trade-off according to the design specification.

Note that each of the second to sixth embodiments can be applied to the seventh embodiment.

As described above, according to the seventh embodiment of the present technology, since the phase compensation capacitor 642 is inserted between the nodes whose potential is determined with reference to the ground, it is possible to reduce the capacitance value required when phase compensation is performed.

Note that the above-described embodiments describe examples for embodying the present technology, and there is a correspondence relationship between matters in the embodiments and the matters specifying the invention in the claims. Similarly, the matters specifying the invention in the claims and matters with the same names in the embodiments of the present technology have correspondence relationships, respectively. However, the present technology is not limited to the embodiments and may be embodied with various modifications of the embodiment without departing from the spirit thereof.

Note that effects described in the present specification are merely examples and are not limited, and other effects may be provided.

Note that the present technology may also have the following configuration.

(1) A reference voltage generation circuit including:
a proportional to absolute temperature (PTAT) current generation unit including a first current source and a second current source which are connected in parallel to one of a power supply voltage and a ground voltage, a pair of bipolar transistors which is connected in parallel to a current mirror circuit including the first current source and the second current source, and a first resistor which is connected to an emitter of one of the pair of bipolar transistors;
a complementary to absolute temperature (CTAT) current generation unit which includes a third current source and a second resistor that are inserted in series between the power supply voltage and the ground voltage, and in which a connection node between the third current source and the second resistor is connected in common to gates of the pair of bipolar transistors; and
an output unit which outputs a reference voltage according to an addition value of a PTAT current supplied by the first current source and the second current source and a CTAT current supplied by the third current source.

(2) The reference voltage generation circuit according to (1), in which the output unit includes:
a fourth current source which replicates the CTAT current and supplies the CTAT current that has been replicated;
a fifth current source that replicates the PTAT current and supplies the PTAT current that has been replicated; and
a third resistor which is connected in common to the fourth current source and the fifth current source.

(3) The reference voltage generation circuit according to (2), in which the first current source, the second current source, the third current source, the fourth current source, and the fifth current source are metal oxide semiconductor (MOS) transistors.

(4) The reference voltage generation circuit according to (2), in which the first current source, the second current source, the third current source, the fourth current source, and the fifth current source are bipolar transistors.

(5) The reference voltage generation circuit according to any one of (2) to (4), in which the first current source, the second current source, the third current source, the fourth current source, and the fifth current source are connected in parallel to the power supply voltage.

(6) The reference voltage generation circuit according to any one of (2) to (4), in which the first current source, the second current source, the third current source, the fourth current source, and the fifth current source are connected in parallel to the ground voltage.

(7) The reference voltage generation circuit according to any one of (2) to (6),
in which the output unit further includes a sixth current source which replicates the PTAT current and supplies the PTAT current that has been replicated, and
the third resistor is connected in common to the fourth current source, the fifth current source, and the sixth current source.

(8) The reference voltage generation circuit according to any one of (2) to (6),
in which the output unit further includes a fourth resistor which is inserted between the third resistor and the fifth current source, and
the fourth current source is connected to a connection node between the third resistor and the fourth resistor.

(9) The reference voltage generation circuit according to any one of (2) to (8) further including:
a base current detection unit which detects a base current of the pair of bipolar transistors.

(10) The reference voltage generation circuit according to (9), in which the base current detection unit adds the base current to the CTAT current supplied by the third current source.

(11) The reference voltage generation circuit according to (9) in which the base current detection unit subtracts the base current from a current flowing through the third resistor.

(12) The reference voltage generation circuit according to (9), in which the base current detection unit corrects the PTAT current with the base current and outputs the PTAT current that has been corrected.

(13) The reference voltage generation circuit according to any one of (1) to (12) further including:
a replica circuit which generates the PTAT current and supplies the PTAT current to the output unit,
in which the output unit outputs a current obtained by adding the PTAT current supplied by the replica circuit to the CTAT current as a reference current together with the reference voltage.

(14) The reference voltage generating circuit according to any one of (1) to (13), in which the PTAT current generation unit includes a folded-back differential circuit.

(15) The reference voltage generating circuit according to (14) further including:
a phase compensation capacitor which is inserted between the PTAT current generation unit and a connection node between the third current source and the second resistor,
in which the PTAT current generation unit further includes a pair of transistors that is cascode connected, and
a connection node between the pair of transistors is connected to the phase compensation capacitor.

(16) An electronic device including:
an integrated circuit;
a proportional to absolute temperature (PTAT) current generation unit including a first current source and a second current source which are connected in parallel to one of a power supply voltage and a ground voltage, a pair of bipolar transistors which is connected in parallel to a current mirror circuit including the first current source and the second current source, and a first resistor which is connected to an emitter of one of the pair of bipolar transistors;
a complementary to absolute temperature (CTAT) current generation unit which includes a third current source and a second resistor that are inserted in series between the power supply voltage and the ground voltage, and in which a connection node between the third current source and the second resistor is connected in common to gates of the pair of bipolar transistors; and
an output unit which outputs to the integrated circuit a reference voltage according to an addition value of a PTAT current supplied by the first current source and the second current source and a CTAT current supplied by the third current source.

### REFERENCE SIGNS LIST

100 Electronic device
110 Integrated circuit
200 Reference voltage generation circuit
300 PTAT current generation unit
301, 402, 503, 504, 641 Resistor
310, 320, 430, 540, 550 Current source
311, 321, 341, 351, 431, 541, 551, 561, 571, 611 to 613, 618, 621 pMOS transistor
312, 322, 331 to 334, 432, 542, 552, 615, 622 Bipolar transistor
313, 323, 361, 371, 381, 391, 433, 543, 553, 614, 616, 617 nMOS transistor
400 CTAT current generation unit
500 Output unit
610 Base current detection unit
620 Replica circuit
630, 642 Phase compensation capacitor

1. A reference voltage generation circuit comprising:
a proportional to absolute temperature (PTAT) current generation unit including a first current source and a second current source which are connected in parallel to one of a power supply voltage and a ground voltage, a pair of bipolar transistors which is connected in parallel to a current mirror circuit including the first current source and the second current source, and a first resistor which is connected to an emitter of one of the pair of bipolar transistors;
a complementary to absolute temperature (CTAT) current generation unit which includes a third current source and a second resistor that are inserted in series between the power supply voltage and the ground voltage, and in which a connection node between the third current source and the second resistor is connected in common to gates of the pair of bipolar transistors;
an output unit which outputs a reference voltage according to an addition value of a PTAT current supplied by the first current source and the second current source and a CTAT current supplied by the third current source; and
a replica circuit which generates the PTAT current and supplies the PTAT current to the output unit,
the output unit outputting a current obtained by adding the PTAT current supplied by the replica circuit to the CTAT current as a reference current together with the reference voltage.

2. The reference voltage generation circuit according to claim 1,
wherein the output unit includes:
a fourth current source which replicates the CTAT current and supplies the CTAT current that has been replicated;
a fifth current source which replicates the PTAT current and supplies the PTAT current that has been replicated; and
a third resistor which is connected in common to the fourth current source and the fifth current source.

3. The reference voltage generation circuit according to claim 2,
wherein the first current source, the second current source, the third current source, the fourth current source, and the fifth current source are metal oxide semiconductor (MOS) transistors.

4. The reference voltage generation circuit according to claim 2,
wherein the first current source, the second current source, the third current source, the fourth current source, and the fifth current source are bipolar transistors.

5. The reference voltage generation circuit according to claim 2,
wherein the first current source, the second current source, the third current source, the fourth current source, and the fifth current source are connected in parallel to the power supply voltage.

6. The reference voltage generation circuit according to claim 2,
wherein the first current source, the second current source, the third current source, the fourth current source, and the fifth current source are connected in parallel to the ground voltage.

7. The reference voltage generation circuit according to claim 2,
wherein the output unit further includes a sixth current source which replicates the PTAT current and supplies the PTAT current that has been replicated, and
the third resistor is connected in common to the fourth current source, the fifth current source, and the sixth current source.

8. The reference voltage generation circuit according to claim 2,
wherein the output unit further includes a fourth resistor which is inserted between the third resistor and the fifth current source, and
the fourth current source is connected to a connection node between the third resistor and the fourth resistor.

9. The reference voltage generation circuit according to claim 2, further comprising:
a base current detection unit which detects a base current of the pair of bipolar transistors.

10. The reference voltage generation circuit according to claim 9,
wherein the base current detection unit adds the base current to the CTAT current supplied by the third current source.

11. The reference voltage generation circuit according to claim 9,
wherein the base current detection unit subtracts the base current from a current flowing through the third resistor.

12. The reference voltage generation circuit according to claim 9,
wherein the base current detection unit corrects the PTAT current with the base current and outputs the PTAT current that has been corrected.

13. The reference voltage generation circuit according to claim 1, further comprising:
a replica circuit which generates the PTAT current and supplies the PTAT current to the output unit,
wherein the output unit outputs a current obtained by adding the PTAT current supplied by the replica circuit to the CTAT current as a reference current together with the reference voltage.

14. The reference voltage generating circuit according to claim 1,
wherein the PTAT current generation unit includes a folded-back differential circuit.

15. The reference voltage generating circuit according to claim 14, further comprising:
a phase compensation capacitor which is inserted between the PTAT current generation unit and a connection node between the third current source and the second resistor,
wherein the PTAT current generation unit further includes a pair of transistors that is cascode connected, and
a connection node between the pair of transistors is connected to the phase compensation capacitor.

16. An electronic device comprising:
an integrated circuit;
a proportional to absolute temperature (PTAT) current generation unit including a first current source and a second current source which are connected in parallel to one of a power supply voltage and a ground voltage, a pair of bipolar transistors which is connected in parallel to a current mirror circuit including the first current source and the second current source, and a first resistor which is connected to an emitter of one of the pair of bipolar transistors;
a complementary to absolute temperature (CTAT) current generation unit which includes a third current source and a second resistor that are inserted in series between the power supply voltage and the ground voltage, and in which a connection node between the third current source and the second resistor is connected in common to gates of the pair of bipolar transistors;
an output unit which outputs to the integrated circuit a reference voltage according to an addition value of a PTAT current supplied from the first current source and the second current source and a CTAT current supplied from the third current source; and
a replica circuit which generates the PTAT current and supplies the PTAT current to the output unit,
the output unit outputting a current obtained by adding the PTAT current supplied by the replica circuit to the CTAT current as a reference current together with the reference voltage.
